(19) United States
(12) Patent Application Publication
(10) Pub. No.: US 2015/0009352 A1
(43) Pub. Date: Jan. 8, 2015

(54) IMAGING APPARATUS AND METHOD FOR CONTROLLING THE SAME

(71) Applicant: CANON KABUSHIKI KAISHA, Tokyo (JP)

(72) Inventor: Genjiro Shibagami, Tokyo (JP)

(21) Appl. No.: 14/320,286

(22) Filed: Jun. 30, 2014

(30) Foreign Application Priority Data
Jul. 2, 2013 (JP) 2013-139006

(51) Int. Cl. H04N 5/235; H04N 5/232

(52) U.S. Cl. CPC H04N 5/2355; H04N 5/23212
USPC 348/218.1

(57) ABSTRACT

An imaging apparatus for improving the detection accuracy of in-focus positions of an imaging optical system when a composite image is acquired and a method for controlling the same are provided. The imaging apparatus detects in-focus positions of the imaging optical system respectively corresponding to a plurality of images with different exposures used to generate the composite image, and selects the in-focus position used to control an operation of the imaging apparatus out of the detected plurality of in-focus positions based on a predetermined condition.

### BACKGROUND OF THE INVENTION

1. Field of the Invention

The present invention relates to an imaging apparatus and a method for controlling the same, and more particularly, to an imaging apparatus capable of acquiring an image having an enlarged dynamic range and a method for controlling the same.

2. Description of the Related Art

Conventionally, an image sensor (a charge coupled device (CCD) image sensor, a complementary metal oxide semiconductor (CMOS) image sensor, etc.) used in a digital camera has a dynamic range (a range of an input luminance representable by an output value) narrower than a silver-halide film. As a method for obtaining an image having a dynamic range wider than the dynamic range of the image sensor, a technique referred to as a high dynamic range (HDR) is known. The HDR technique is a method for combining a plurality of images (e.g., a high-exposure image with a large amount of exposure and a low-exposure image with a small amount of exposure) obtained by shooting the same scene with different amounts of exposure (see Japanese Patent Application Laid-Open No. 11-164195).

In recent years, a technique for generating an HDR image using an image sensor capable of capturing a plurality of images with different exposures in one frame period is discussed (see Japanese Patent Application Laid-Open No. 2011-244309).

In HDR shooting for combining a plurality of images to generate a frame image (composite image), when a focus signal required for the shooting is detected from the composite image, a focus signal reflection timing for detecting a focus state is delayed. This problem also exists in not only a configuration in which a plurality of images with different exposures is acquired in a plurality of frame periods, as discussed in Japanese Patent Application Laid-Open No. 11-164195, but also a configuration in which a plurality of images with different exposures can be acquired in one frame period, as discussed in Japanese Patent Application Laid-Open No. 2011-244309.

For example, consider an automatic focus (AF) control operation of a contrast AF system for acquiring an AF evaluation value representing sharpness of an image based on the image, and controlling a focus lens position so that the AF evaluation value reaches its maximum to perform focus adjustment when an HDR image is captured. In this case, the AF control operation is performed using an AF evaluation value detected from a composite image, so that the AF evaluation value is reflected in the shooting only after images are combined. Thus, responsiveness of AF to movement of an object deteriorates. Therefore, the AF evaluation value is desirably detected and reflected using the images that have not been combined.

However, when the AF evaluation value is detected by always using only one of the images that have not yet been combined (e.g., a high-exposure image or a low-exposure image), a highly accurate AF evaluation value may be undetectable from the uncombined images, depending on a relationship between an amount of exposure and a captured scene.

For example, in a significantly dark scene where a character is shot with a night scene as a background, an AF evaluation value cannot be detected with high accuracy from a low-exposure image. Further in the case where the captured scene is sufficiently bright and a dynamic range of the captured scene is wide, an object may be overexposed or underexposed, therefore, an AF evaluation value cannot be detected with high accuracy from a high-exposure image. A similar problem occurs in a backlight scene (a scene where a background of a main object is significantly bright) and a tunnel scene (a scene where a background is dark and an area which a main object occupies is small).

### SUMMARY OF THE INVENTION

The present invention is directed to providing an imaging apparatus for improving the detection accuracy of in-focus positions of an imaging optical system when a composite image is acquired and a method for controlling the same.

According to an aspect of the present invention, a focus detection method includes detecting a focus signal from each of a plurality of image signals with different exposure conditions output from an image sensor to combine images to generate a composite image in one frame, and acquiring a plurality of in-focus positions respectively corresponding to the exposure conditions based on the detected focus signals and selecting the in-focus position where focusing is to be performed out of the plurality of in-focus positions.

Further features of the present invention will become apparent from the following description of exemplary embodiments with reference to the attached drawings.

### BRIEF DESCRIPTION OF THE DRAWINGS

FIG. 1 is a block diagram illustrating an example of a functional configuration of an imaging apparatus according to a first exemplary embodiment.

FIG. 2 illustrates an example of a configuration of an image sensor in the imaging apparatus according to the first exemplary embodiment.

FIG. 3 is a timing chart for illustrating an operation of a vertical scanning unit performed when a plurality of images with different exposures is acquired in the imaging apparatus according to the first exemplary embodiment.

FIG. 4 is a flowchart for illustrating operations relating to composite image acquisition in the imaging apparatus according to the first exemplary embodiment.

FIGS. 5A and 5B respectively illustrate focus detection areas set in an imaging screen including a plurality of images with different exposures in the imaging apparatus according to the first exemplary embodiment.

FIG. 6A illustrates an operation for selecting an AF evaluation value at different areas of a low image; and FIGS. 6B, 6C, and 6D respectively illustrate statistical graphs (luminance value histograms) with signal levels respectively corresponding to the areas of AF evaluation of FIG. 6A, according to the first exemplary embodiment.

FIG. 7A illustrates an operation for selecting an AF evaluation value at different areas of a high image; and FIGS. 7B, 7C, and 7D respectively illustrate statistical graphs (luminance value histograms) with signal levels respectively corresponding to the areas of AF evaluation of FIG. 7A, according to the first exemplary embodiment.

FIG. 8 is a flowchart for illustrating operations relating to zone updating determination (S410) illustrated in FIG. 4.

FIG. 9 is a flowchart for illustrating operations relating to peak position (S414) selection illustrated in FIG. 4.

FIG. 10 is a flowchart for illustrating operations relating to composite image acquisition in an imaging apparatus according to a second exemplary embodiment.

FIG. 11 is a flowchart for illustrating operations relating to in-focus position selection illustrated in FIG. 10.

### DESCRIPTION OF THE EMBODIMENTS

Various exemplary embodiments, features, and aspects of the invention will be described in detail below with reference to the drawings.

The following exemplary embodiments are illustrative of the general principles and structure of a focus detection apparatus, but the present invention is not limited to a specific configuration described in the present exemplary embodiments.

In the specification, “focus signal” refers to an AF evaluation value in a contrast AF system for acquiring an AF evaluation value representing sharpness of an image based on the image. In the contrast AF system, a focus lens position is controlled such that the AF evaluation value reaches its maximum to perform focus adjustment. For example, an image sensor may include focus detection pixels for dividing a pupil area of an imaging optical system and photoelectrically converting an object image from the divided pupil area. “Focus signal” may also be the output signal, in a phase difference AF system for detecting a phase difference between image signals using output signals of the focus detection pixels to perform focus adjustment. Furthermore, for example, there can be a case where an image sensor is used which includes pixels constituted by a plurality of photoelectric conversion units for dividing one micro lens and an exit pupil. Further, “focus signal” may be the output signal in a phase difference AF system. In the phase difference AF system, a phase difference between image signals is detected using a plurality of signals output from pixels, which are obtained by photoelectrically converting light beams that have respectively passed through different exit pupils of an optical system. The output signal in the phase difference AF system refers to a phase difference and a defocus amount.

### <Configuration of Imaging Apparatus>

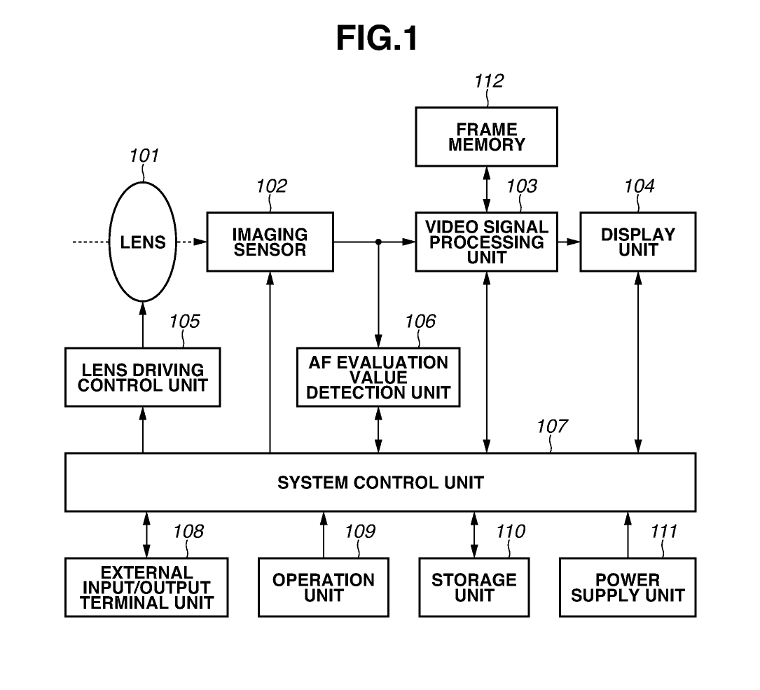

FIG. 1 is a block diagram illustrating an example of a functional configuration of an imaging apparatus according to a first exemplary embodiment.

A lens group 101 is a lens group constituting an imaging optical system. The lens group 101 includes a focus lens for adjusting an in-focus distance, and may also include a non-illustrated zoom lens for adjusting magnification of an image. A position of the focus lens is changeable along an optical axis direction. The system control unit 107 (system controller) controls the position of the focus lens via a lens driving control unit 105 based on an AF evaluation value detected by a focus signal detection unit 106. The lens group 101 and the lens driving control unit 105 may be implemented in an interchangeable lens unit that is detachably attached to a camera body.

Light entering via the lens group 101 is formed as an optical image of an object on an image forming surface of an image sensor 102 including a CCD or CMOS image sensor.

The image sensor 102 includes a pixel portion that photoelectrically converts the light incident on each of pixels into an analog signal. In the image sensor 102, an analog-to-digital (A/D) conversion circuit converts the analog signal into a digital signal, and a digital signal processing circuit corrects noises of the signal (details thereof will be described below). The A/D conversion circuit and the digital signal processing circuit may be provided separately from the image sensor 102. Circuits for performing processing such as selection of an in-focus position, determination of the focus lens position during focus bracket shooting, and scene determination in the focus signal detection unit 106 and the system control unit 107 described below may be provided in the image sensor 102.

The focus signal detection unit 106 detects an AF evaluation value from image data output by the image sensor 102. In this case, at output timing from the system control unit 107, AF evaluation values serving as focus signals are detected from a high-exposure image and a low-exposure image that have not yet been subjected to processing for combining a plurality of images to generate a frame image. Herein, processing for combining a plurality of images to generate a frame image will be referred to as high dynamic range processing (HDR processing).

The system control unit 107 determines a value (or amount) to control the lens group 101 (the focus lens) based on detected AF evaluation values, and outputs the control amount to the lens driving control unit 105.

The lens driving control unit 105 drives the focus lens included in the lens group 101 in the optical axis direction based on the control amount received from the system control unit 107, and adjusts the in-focus distance of the lens group 101.

A video signal processing unit 103 subjects the image data input from the image sensor 102 to correction parameter generation processing and image signal correction processing. A frame memory 112 stores the image data input to the video signal processing unit 103. The system control unit 107 controls the storage of the image data in the frame memory 112, therefore the system control unit 107 also functions as a storage control unit. The video signal processing unit 103 subjects the image data stored in the frame memory 112 to predetermined processing to generate a composite image, and outputs the generated composite image as an image signal that can be displayed on a display unit 104.

The system control unit 107 controls the entire system. To that end, the system control unit 107 includes a central processing unit (CPU) implemented by one or more microprocessors, read-only memory (ROM), random access memory (RAM), analog-to-digital (A/D) converters, D/A converters, communication interface circuit(s), etc.

More specifically, the system control unit 107 controls operations and processing of each of the lens driving control unit 105, the image sensor 102, the video signal processing unit 103, and the focus signal detection unit 106 provided in each imaging optical system. The system control unit 107 also controls the display unit 104, an external input/output terminal unit 108, an operation unit 109, a storage unit 110, and a power supply unit 111. The system control unit 107 performs processing according to a program to be interpreted and executed by the central processing unit (CPU), illustration of which is omitted.

The external input/output terminal unit 108 is an external interface circuit for connecting an external device to the imaging apparatus, and is provided with a connector conforming to standards such as a high-definition multimedia interface (HDMI) (registered trademark) and a universal serial bus (USB). The operation unit 109 is an input device group for a user to issue an instruction and make a setting to the imaging apparatus. The operation unit 109 includes buttons and keys generally provided in the imaging apparatus, i.e., a release button, a recording/reproduction mode changing switch, a direction key, a determination/execution key, and a menu button. The operation unit 109 also includes a configuration for implementing an input method not using a hardware key such as a touch panel or a voice input. The storage unit 110 includes a storage medium, and records a captured moving image or still image on the recording medium. The recording medium may be either one or both of a detachable type recording medium such as a semiconductor memory card and a fixed type recording medium such as a built-in hard disk drive (HHD) or solid state drive (SSD). The power supply unit 111 includes a secondary battery and a power supply circuit, for example, and supplies power for driving each of the units in the imaging apparatus.

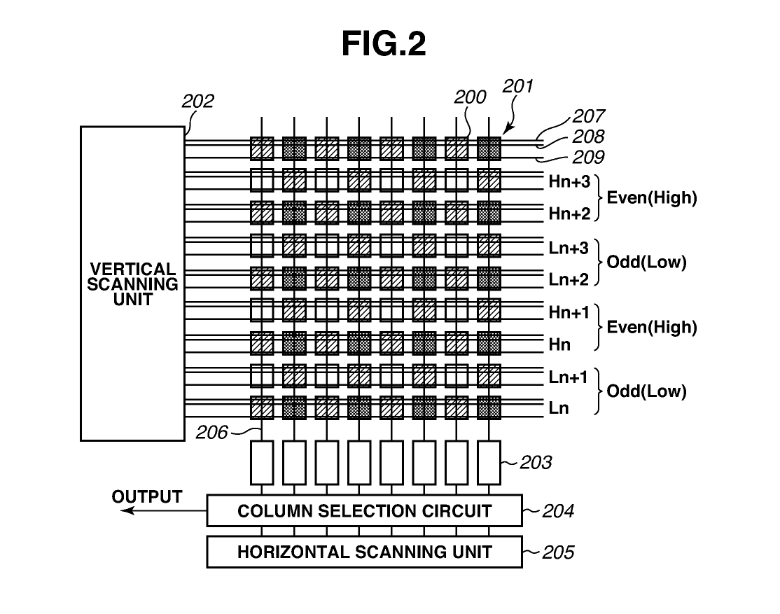

FIG. 2 illustrates as an example, a CMOS image sensor 102 according to the exemplary embodiment of the present invention. The image sensor 102 includes a pixel array unit 201 constituted by a large number of picture elements or unit pixels (hereinafter merely referred to as “pixels”) 200 including photoelectric conversion elements two-dimensionally arranged in a matrix shape.

The image sensor 102 includes a vertical scanning unit 202, column signal processing circuits 203, a column selection circuit 204, and a horizontal scanning unit 205, for example, as peripheral circuits of the pixel array unit 201.

In the unit pixel 200, a vertical signal line 206 is wired for each column, and driving control lines, e.g., a reset control line RST 207, a transfer control line TRS 208, and a selection control line SEL 209 are wired for each line.

The vertical scanning unit 202 illustrated in FIG. 2 includes a line selection circuit and a driver circuit.

The line selection circuit includes a shift register or an address decoder. The line selection circuit generates pixel driving pulses such as a transfer pulse, a reset pulse and a selection pulse for vertically scanning each of the unit pixels 200 in the pixel array unit 201 line by line under the control of the system control unit 107.

The driver circuit supplies the transfer pulse, the reset pulse, and the selection pulse, which respectively have predetermined voltages for turning on/off transistors in the unit pixels 200, to the unit pixels 200 in synchronization with vertical scanning by the line selection circuit. The driver circuit can also perform processing for supplying the transfer pulse having the voltage intermediate among the voltages for turning on/off the transistors in the unit pixels 200 to the unit pixels 200 in synchronization with the vertical scanning.

The column signal processing circuits 203 are respectively arranged for the columns of the pixel array unit 201. The column signal processing circuit 203 performs predetermined signal processing on an electric signal output from each of the unit pixels 200 on a readout line selected by the vertical scanning via the vertical signal line 206, generates a pixel signal corresponding to a signal charge read out of the unit pixel 200, and temporarily retains the generated pixel signal. For example, the column signal processing circuit 203 performs correlated double sampling (CDS) processing as signal processing, to reduce a reset noise and a pixel-specific fixed pattern noise such as a threshold value variation of an amplification transistor 303. The column signal processing circuit 203 also performs analog digital (AD) conversion processing for converting an analog signal into a digital signal.

The column selection circuit 204 includes a shift register or an address decoder. The column selection circuit 204 performs horizontal scanning for each pixel column of the pixel array unit 201, and the horizontal scanning unit 205 reads out the pixel signals temporarily retained in the column signal processing circuit 203 in a horizontal scan order.

The horizontal scanning unit 205 includes a horizontal selection switch, and sequentially reads out the pixel signals temporarily retained in the column signal processing circuit 203 for each pixel column by horizontal scanning performed by the column selection circuit 204, and outputs image signals line by line.

The system control unit 107 controls respective operations of the vertical scanning unit 202 and the column selection circuit 204, scans the unit pixels 200 in the pixel array unit 201 in a vertical direction line by line, and outputs by the horizontal scanning the pixel signals read out by the vertical scanning.

Generally, a single plate color image sensor includes color filters of a primary color Bayer array including pixels R, G1, B, and G2 regularly arranged using two pixels in length and two pixels in width as a repeating unit.

Also in the present exemplary embodiment, the image sensor 102 includes color filters of the primary color Bayer array.

In the image sensor 102 including the color filters arranged in the Bayer array, two lines, i.e., one line including pixels R and G and one line including pixels G and B constitute one set of lines. Accordingly, in the present exemplary embodiment, an “Even” line for long-time exposure and an “Odd” line for short-time exposure are set using adjacent two lines as a unit, to control scanning of the pixel array unit 201, as illustrated in FIG. 2. More specifically, a set of two lines Ln and Ln+1 corresponds to a short-time exposure and a set of two lines Hn and Hn+1 corresponds to a long-time exposure.

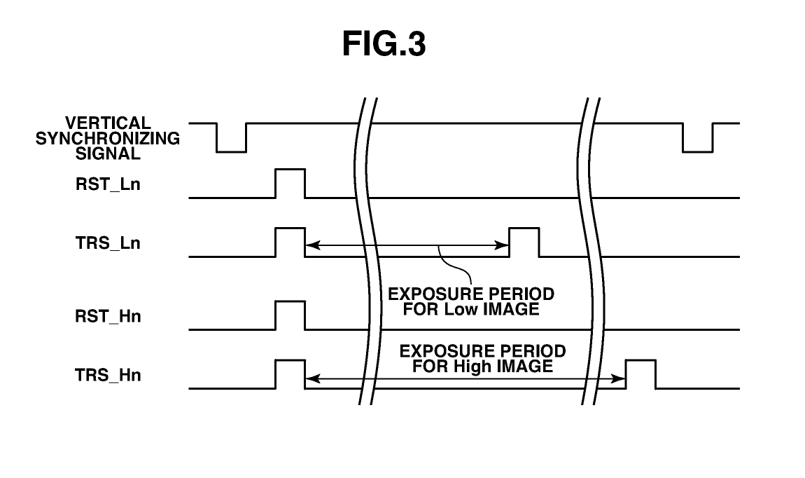

FIG. 3 is a timing chart illustrating signals to be generated by the vertical scanning unit 202 to acquire a plurality of images with different exposures for generating a composite image in the present exemplary embodiment in one frame period. In the present case, FIG. 3 shows signal timings of a reset control line RST_Ln and a transfer control line TRS_Ln in the Odd line Ln corresponding to the short-time exposure and a reset control line RST_Hn and a transfer control line TRS_Hn in the Even line Hn corresponding to the long-time exposure.

In the present exemplary embodiment, in a scanning operation as described below, a plurality of images with different amounts of exposures is sequentially acquired while the focus lens is moved, to respectively acquire AF evaluation values while generating a composite image and displaying the generated composite image as a live view image on the display unit 104. In the case, to facilitate description and understanding, the two images with different amounts of exposures are combined, to generate one composite image. However, three or more images may be used to generate one composite image. The present exemplary embodiment includes not only capturing a live view image to be displayed on the display unit 104 during a shooing standby but also capturing a moving image for recording.

In the following description, an overexposed image captured with a more exposure than a proper exposure, may be referred to as a High image, an image captured with the proper exposure may be referred to as a Middle image, and an underexposed image captured with a less exposure than the proper exposure may be referred to as a Low image.

The transfer control line TRS and the reset control RST rise so that a charge stored in a photodiode 300 serving as a photoelectric conversion unit is reset to start an exposure (charge accumulation). The operations are sequentially performed in a predetermined order for each of the lines in the pixel array unit 201 under conditions set by the system control unit 107.

Then, in the Odd line for the Low image, the TRS_Ln signal for the Odd line sequentially rises after a lapse of an exposure time for acquiring the Low image. Thus, the charge stored in the photodiode 300 is read out to a selection transistor 304, and is output via the column selection circuit 204. From the TRS_Ln signal, the Low image is obtained.

The TRS_Hn signal for the Even line sequentially rises after a lapse of an exposure time for acquiring the High image, and the charge stored in the photodiode 300 is read out to the selection transistor 304, and is output via the column selection circuit 204. From the TRS_Hn signal, the High image is obtained.

The high-exposure image and the low-exposure image are acquired by changing an exposure condition, e.g., changing an amount of exposure of the photodiode 300 or its gain. Therefore, an exposure time may be changed as described above, and the amount of exposures may be changed by changing an opening to the photodiode 300.

### <Operation Flow of Imaging Apparatus>

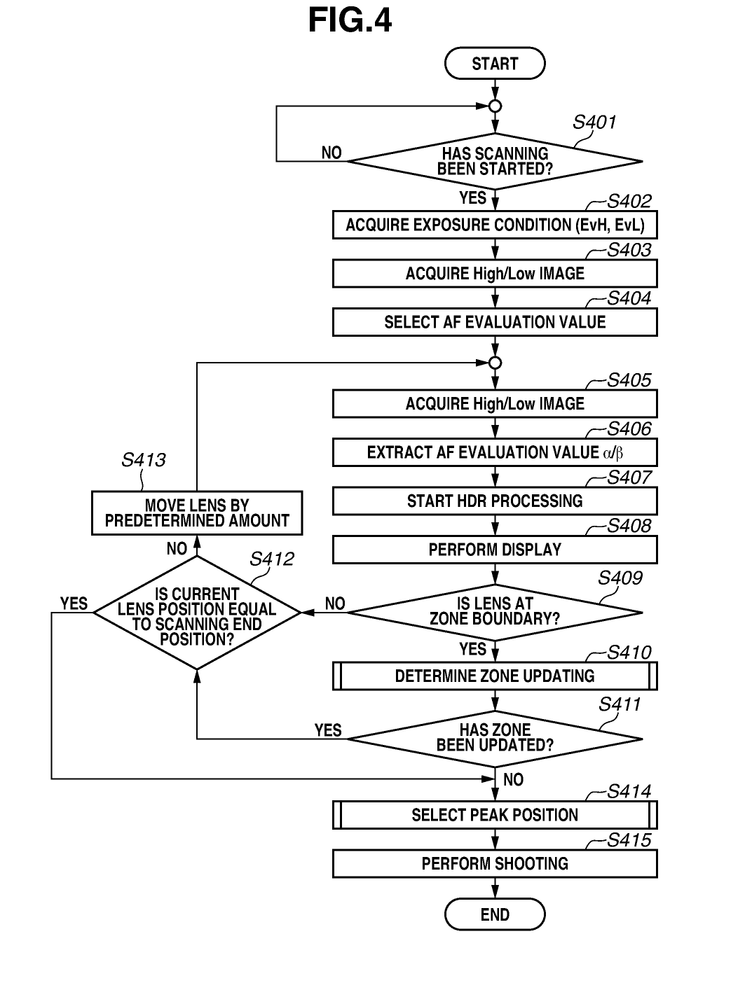

Operations of the imaging apparatus according to the present exemplary embodiment will be specifically described below with reference to a flowchart illustrated in FIG. 4. In the following description, an AF evaluation value α is detected based on the High image, and an AF evaluation value β is detected based on the Low image.

When a power supply is turned on by operating a power switch in the operation unit 109, power is supplied to each of the units from the power supply unit 111. The system control unit 107 performs various types of initial setting, to enter a shooting standby state, and to start to shoot a live view video to be displayed on the display unit 104. In this case, composite image capturing is carried out.

In step S401, the system control unit 107 determines whether a scanning operation has been started. The scanning operation is an operation for sequentially acquiring AF evaluation values representing sharpness of images based on image signals while moving the focus lens in a predetermined range (e.g., a range from an infinite distance end to a closest distance end). If it is determined that the scanning operation has been started (YES in step S401), the processing proceeds to step S402.

In step S402, the system control unit 107 calculates a proper exposure condition using any known method as a reference, and determines a High-image exposure (Ev (H)) and a Low-image exposure (Ev (L)). In the High-image exposure (Ev (H)), a target luminance level adjusted plus one step, and in the Low-image exposure (Ev (L)), a target luminance level adjusted minus one step. In this case, the system control unit 107 adjusts a shutter speed (further, sensitivity (a gain amount) is adjusted, as needed) by one step from the proper exposure condition, to adjust and determine the Ev (H) by plus one step and the Ev (L) by minus one step. The system control unit 107 controls a charge accumulation time in the image sensor 102, to control the shutter speed.

In step S403, the system control unit 107 performs control, to capture an image under different exposure conditions on the Odd and Even lines in the image sensor 102 based on the exposure conditions Ev (H) and Ev (L) determined in step S402. Thus, the High image and the Low image during one frame period are acquired. The system control unit 107 stores the acquired High image and Low image in the frame memory 112. In step S404, the system control unit 107 uses the High image and the Low image to determine selection of an AF evaluation value.

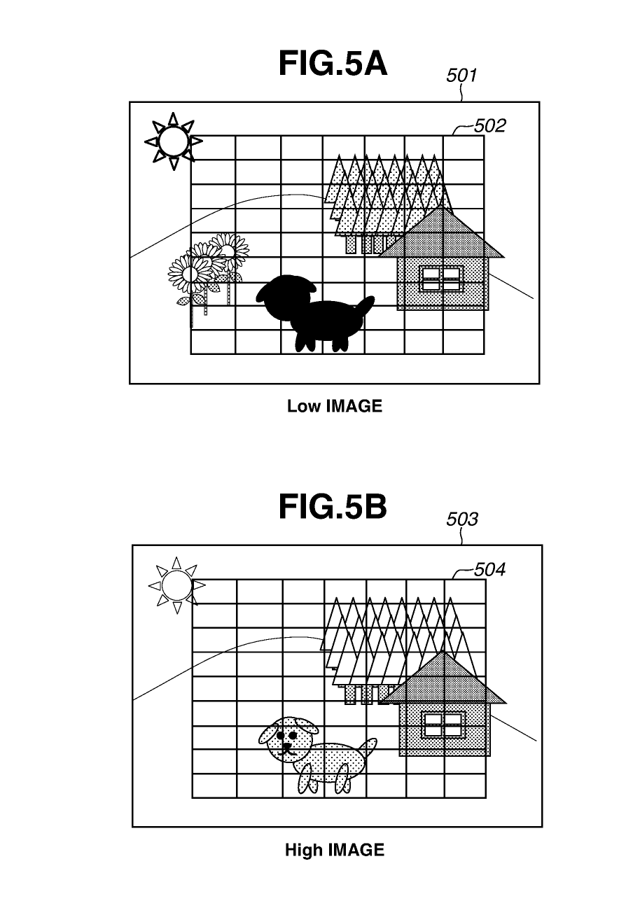

More specifically, in step S404, the system control unit 107 acquires a signal level (a luminance value) of pixels in each of the High image and the Low image. The system control unit 107 determines whether an AF evaluation value α is selected, whether an AF evaluation value β is selected, or whether both the AF evaluation values α and β are selected in each of a plurality of focus detection areas set in an imaging screen (described below with reference to FIG. 5) using data representing the luminance value. The AF evaluation value is selected at this time point because, if an image is overexposed or underexposed as the luminance value data, the reliability of an AF evaluation value obtained from the image may deteriorate, and the determination using the low-reliability AF evaluation value leads to erroneous detection. To previously exclude such a case, the AF evaluation value is selected. The AF evaluation values corresponding to the focus detection areas are calculated using image signals in the focus detection areas.

### <Selection of AF Evaluation Value>

The selection of the AF evaluation value for detecting an in-focus position will be specifically described. A method using a histogram of the signal level (luminance value) of the pixels in each of focus detection areas will be described with reference to FIGS. 5, 6, and 7.

FIG. 5A illustrates focus detection areas (502) in a matrix of nine rows and seven columns arranged in a Low image (501), and FIG. 5B illustrates focus detection areas (504) in a matrix of nine rows and seven columns arranged in a High image (503).

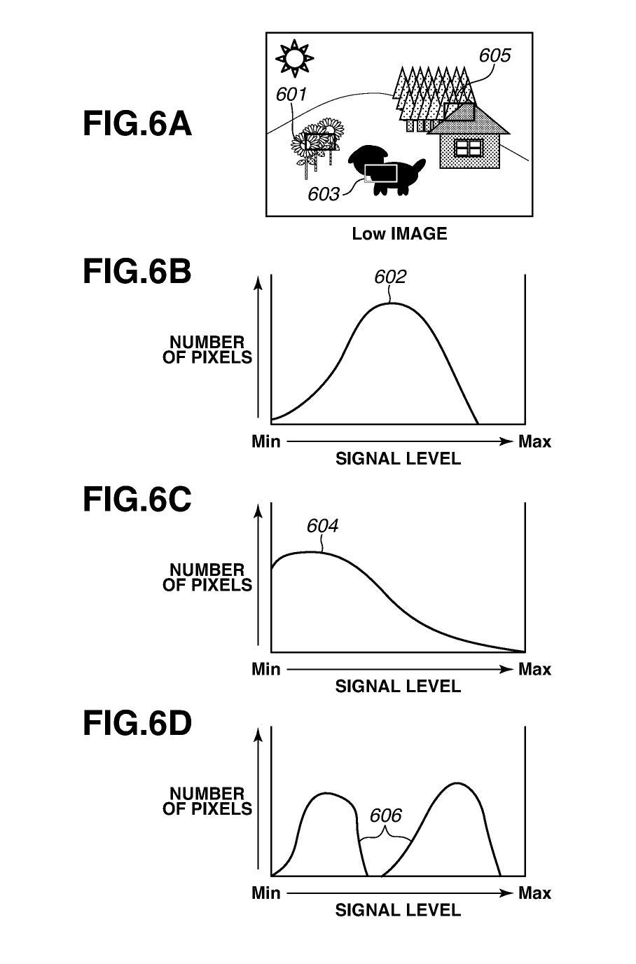

FIG. 6A illustrates a focus detection area (601) partially covering a flower, a focus detection area (603) partially covering a dog, and a focus detection area (605) partially covering a house and a tree out of the focus detection areas (502) in a matrix of nine rows and seven columns arranged in the Low image (501).

Graphs illustrated in FIGS. 6B, 6C, and 6D are respectively statistical graphs (luminance value histograms) with the number of pixels and a signal level respectively used as an ordinate and an abscissa. A histogram (602) is a one for the focus detection area (601) partially covering a flower, a histogram (604) is a one for the focus detection area (603) partially covering a dog, and a histogram (606) is a one for the focus detection area (605) partially covering a house and a tree.

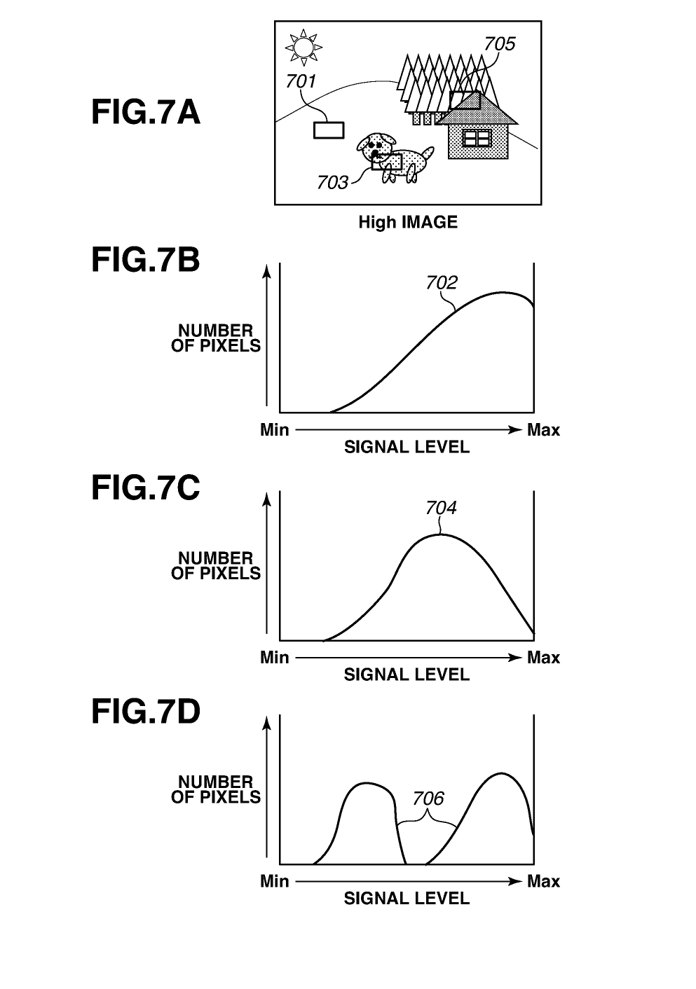

FIG. 7A illustrates a focus detection area (701) partially covering a flower, a focus detection area (703) partially covering a dog, and a focus detection area (705) partially covering a house and a tree out of the focus detection areas (504) in a matrix of nine rows and seven columns arranged in the High image (503).

Graphs illustrated in FIGS. 7B, 7C, and 7D are respectively statistical graphs (luminance value histograms) with the number of pixels and a signal level respectively used as an ordinate and an abscissa. A histogram (702) is a one for the focus detection area (701) partially covering a flower, a histogram (704) is a one for the focus detection area (703) partially covering a dog, and a histogram (706) is a one for the focus detection area (705) partially covering a house and a tree. Thus, the number of Min value of the signal level and the number of Max value of the signal level in each of the histograms for the Low image and the High image can be calculated.

First, a case will be described where the AF evaluation value β detected in the Low image is selected.

The number of the Min value and the number of the Max value in the histogram (602) for the focus detection area (601) partially covering a flower in the Low image are respectively Min_lf and Max_lf. The number of the Min value and the number of the Max value in the histogram (702) for the focus detection area (701) partially covering a flower in the Low image are respectively Min_hf and Max_hf.

If Max_hf is a predetermined number or more, like in the histogram (702) for the focus detection area (701) in the High image, there are many pixels at high signal levels, so that it is determined that the High image is overexposed. The predetermined number is approximately 60 to 80% of the number of pixels within the focus detection area, for example. On the other hand, in the histogram (602) for the focus detection area (601) in the Low image, both Min_lh and Max_lf are less than the predetermined number so that pixels are distributed nearer the center than in the histogram (702) in the High image. Based on the determinations, in the AF evaluation value selection in step S404, the AF evaluation value β detected in the Low image is selected.

A case will be described where the AF evaluation value α detected in the High image is selected.

The number of the Min value and the number of the Max value in the histogram (604) for the focus detection area (603) partially covering a dog in the Low image are respectively Min_ld and Max_ld. The number of the Min value and the number of the Max value in the histogram (704) for the focus detection area (703) partially covering a dog in the High image are respectively Min_hd and Max_hd.

If Min_ld is a predetermined number or more, like in the histogram (604) for the focus detection area (603) in the Low image, there are many pixels at low levels, so that it is determined that the Low image is underexposed. The predetermined number is approximately 60 to 80% of the number of pixels in the focus detection area, for example. On the other hand, in the histogram (704) for the focus detection area (703) in the High image, both Min_hd and Max_hd are less than the predetermined number so that pixels are distributed nearer the center than in the histogram (604) in the Low image. Based on the determinations, in the AF evaluation value selection in step S404, the AF evaluation value α detected in the High image is selected.

Next, a case will be described below where both the AF evaluation value α detected in the High image and the AF evaluation value β detected in the Low image are selected.

The number of the Min value and the number of the Max value in the histogram (606) for the focus detection area (605) partially covering a house and a tree in the Low image are respectively Min_ls and Max_ls. The number of the Min value and the number of the Max value in the histogram (706) for the focus detection area (705) partially covering a house and a tree in the High image are respectively Min_hs and Max_hs.

Since Min_ls, Max_ls, Min_hs, and Max_hs are all less than the predetermined number, pixels are distributed near the center in both the High image and the Low image. Based on this determination, both the AF evaluation value α detected in the High image and the AF evaluation value β detected in the Low image are selected in the AF evaluation value selection in step S404.

### <S405 and Subsequent Steps>

Referring to FIG. 4 again, operations in step S405 and the subsequent steps will be described.

In step S405, the system control unit 107 acquires the High image and the Low image, and stores the acquired images in the frame memory 112.

In step S406, the focus signal detection unit 106 detects the AF evaluation value α for the High image and the AF evaluation value β for the Low image based on each image.

In step S407, the video signal processing unit 103 starts combining processing for generating an HDR image (a composite image) from the High image and the Low image stored in the frame memory 112.

In step S408, the video signal processing unit 103 performs development processing for developing the HDR image that has been generated in step S407. The system control unit 107 displays the HDR image as a live view on the display unit 104 after the development processing. The HDR image, which is displayed in step S408, is a composite image of a High image and a Low image that have been captured in the preceding frame period. If the system control unit 107 is given an instruction to end the operation in step S408, the processing ends. On the other hand, if the imaging is continued, the processing proceeds to step S409.

In step S409, the system control unit 107 examines whether the focus lens is at a boundary position of a previously set zone. If the focus lens is at the boundary position (YES in step S409), the processing proceeds to step S410. If the focus lens is not at the boundary position (No in step S409), the processing proceeds to step S412.

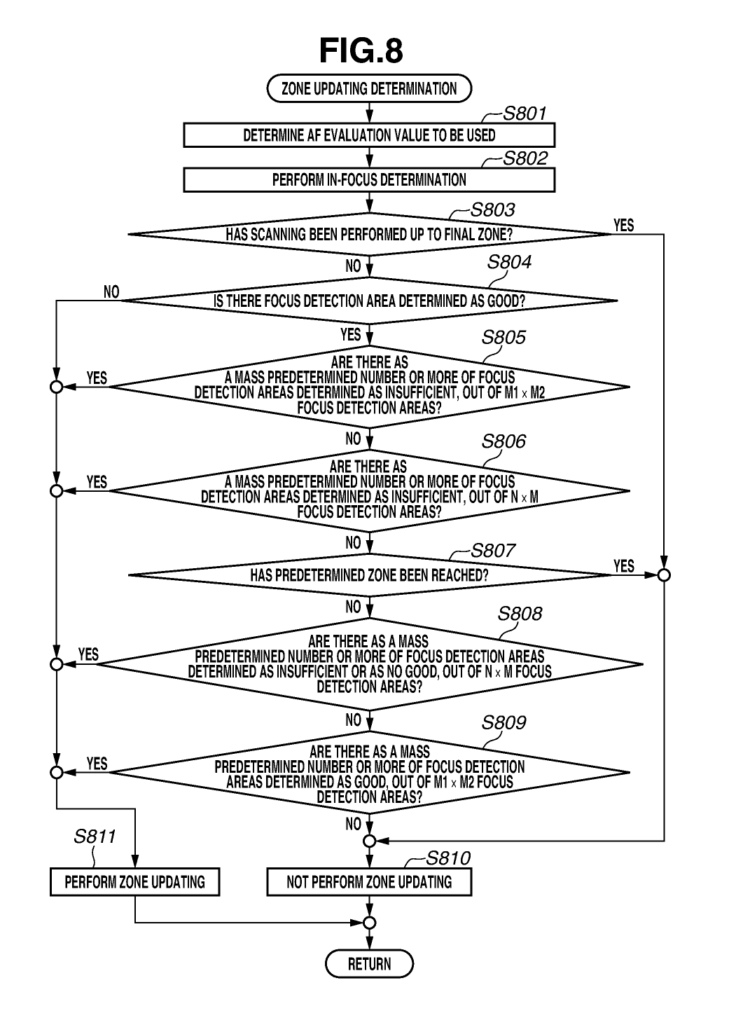

In step S410, the system control unit 107 determines zone updating using the AF evaluation values α and β. The determination of the zone updating will be described below with reference to FIG. 8. “Zone” means each of a plurality of ranges obtained by dividing a predetermined movement range of the focus lens, and “zone updating” means updating a zone where a scanning operation is performed from the current zone to the succeeding zone when the AF evaluation value satisfies a predetermined condition.

In step S411, the system control unit 107 determines whether the zone has been updated as a result of the determination in step S410. If the zone has been updated (YES in step S411), the processing proceeds to step S412. Otherwise (No in step S411), the processing proceeds to step S414.

In step S412, the system control unit 107 examines whether the current focus position is identical with a scanning operation end position. If both the positions are identical (YES in step S412), the processing proceeds to step S414. Otherwise (NO instep S412), the processing proceeds to step S413.

In step S413, the system control unit 107 moves the focus lens by a predetermined amount toward a scanning operation end direction, and the processing returns to step S405.

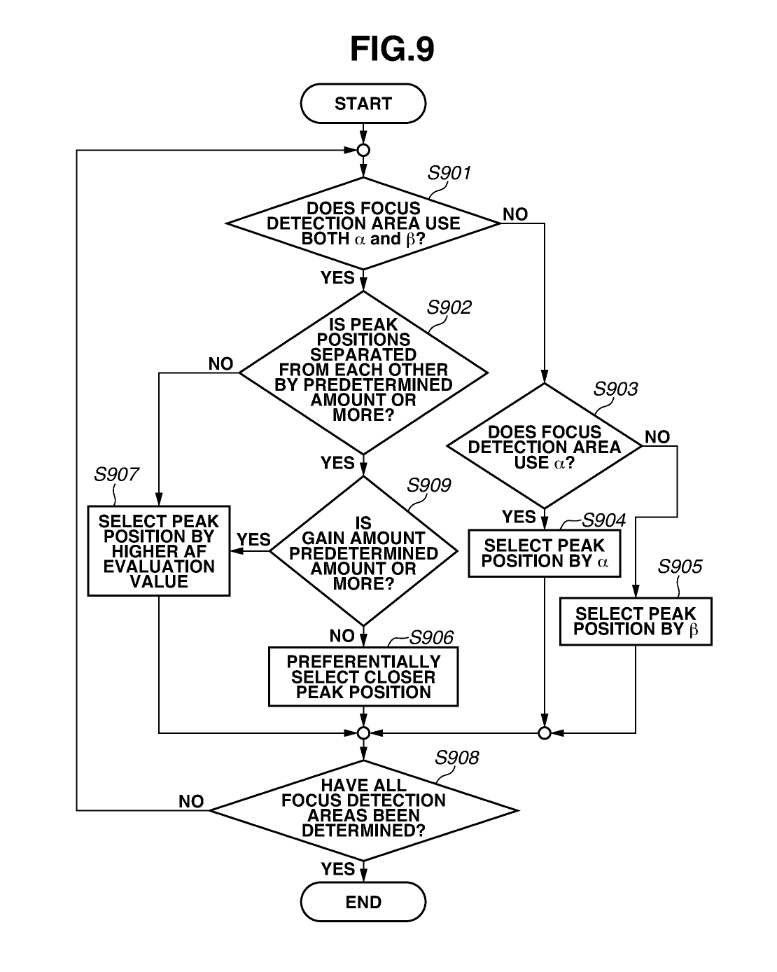

In step S414, the system control unit 107 selects a peak position (a position of the focus lens where the AF evaluation value becomes a peak) in an area arranged within a screen of each of the High image and the Low image that have been acquired in step S405. The processing will be described below with reference to FIG. 9.

In step S415, the system control unit 107 determines a focus lens position for shooting after selecting the peak position in step S414. For example, the number (the frequency of occurrence) of areas where the AF evaluation value reaches its maximum is accumulated for each focus lens position, to generate a histogram representing a distribution of the frequency of occurrence of the areas for the focus lens position. A method for determining the focus lens position for shooting using the histogram can be conceived. At this time, if a predetermined number of (a plurality of) focus lens positions for continuous shooting are determined in descending order of the frequencies of occurrence of the areas, and shooting is performed at the determined focus lens positions, focus bracket shooting can be performed. In the present exemplary embodiment, in the focus bracket shooting which is performed a plurality of times by changing the focus lens position, information about the focus lens position where the AF evaluation value for each of the areas becomes a peak is used. However, the information about the focus lens position where the AF evaluation value for each of the areas becomes a peak may be used to determine a shooting scene and display an icon representing the shooting scene on the display unit 104.

In another operation flow for determining whether the shooting scene has been changed, the determination may be made based on the High image and the Low image, which have been acquired in steps S403 and S405 in FIG. 4. In this case, the processing returns to step S402 when it is determined that the shooting scene has been changed.

### <Zone Updating Determination>

The zone updating determination in step S410 illustrated in FIG. 4 will be described below with reference to FIG. 8. It is determined whether a main object is likely to exist ahead in a scanning direction, i.e., whether an AF scanning operation is to continue. As described in FIG. 5, focus detection areas in a matrix of nine rows and seven columns (N=7 and M=9) are set in a screen.

In step S801, the system control unit 107 first determines whether the AF evaluation value α is to be used, whether the AF evaluation value β is to be used, or whether both the AF evaluation values α and β are to be used while referring to the selection result in step S404 illustrated in FIG. 4.

In step S802, the system control unit 107 then performs in-focus determination for all the set focus detection areas. “In-focus determination” means determining whether a focus lens position where an AF evaluation value becomes a peak is a focus lens position where a focus lens is to be focused. The determination is made depending on whether a difference between the peak and a minimum of the AF evaluation value is a predetermined amount or more, or whether the AF evaluation value has decreased by a predetermined amount or more from the peak. If it is determined that the focus lens is in a sharp focus as a result of the in-focus determination, it is determined as “GOOD”. If the AF evaluation value stops increasing, it is determined as “insufficient”. If it is determined that the focus lens is not in a sharp focus, it is determined as “no good”.

In the focus detection area, where use of the AF evaluation value α has been determined in step S801, the in-focus determination is made using the AF evaluation value α. In the focus detection area, where use of the AF evaluation value β has been determined, the in-focus determination is made using the AF evaluation value β. If it has been determined that both the AF evaluation values α and β are used, the determination is made using both in-focus determination results using the AF evaluation value α and an in-focus determination result using the AF evaluation value β.

When use of both the AF evaluation values α and β has been determined, if both the in-focus determination result using the AF evaluation value α and the in-focus determination result using the AF evaluation value β are focused or unfocused, the focus detection area is determined as “GOOD” or “no good”. If it is determined that either one of the AF evaluation values α or β has stopped increasing, it is determined as “insufficient”.

In step S803, the system control unit 107 then examines whether a scanning operation has been performed up to the final zone. If the scanning operation has been performed up to the final zone (YES in step S803), the processing proceeds to step S810. Otherwise (NO in step S803), the processing proceeds to step S804.

In step S804, the system control unit 107 examines whether there is a focus detection area that has been determined as “GOOD”. If there is a focus detection area that has been determined as “GOOD” (YES in step S804), the processing proceeds to step S805. Otherwise (NO in step S804), the processing proceeds to step S811.

In step S805, the system control unit 107 examines whether there is a mass of a predetermined number or more of focus detection areas that have been determined as “insufficient” out of M1 by M2 focus detection areas at the center. If the mass exists (YES in step S805), the processing proceeds to step S811. Otherwise (NO in step S805), the processing proceeds to step S806. In the present exemplary embodiment, M1=3, M2=5, and the predetermined number is 5 as an example. “Mass” means a state where target focus detection areas obtained as determination results are adjacent to each other.

In step S806, the system control unit 107 examines whether there is a mass of a predetermined number or more of focus detection areas that have been determined as “insufficient” out of L1 by L2 focus detection areas at the center. If the mass exists (YES in step S806), the processing proceeds to step S811. Otherwise (NO in step S806), the processing proceeds to step S807. In the present exemplary embodiment, L1=5, L1=7, and the predetermined number is 10.

In step S807, the system control unit 107 examines whether a predetermined zone previously determined has been reached. If the predetermined zone has been reached (YES in step S807), the processing proceeds to step S810. If the predetermined zone has not been reached (NO in step S807), the processing proceeds to step S808. “Predetermined zone” means a zone where it can be assumed that when an object exists at a closest position in a scannable range, an AF evaluation value increases toward a peak position where the object exists, so that a focus detection area is determined as “insufficient”. If the mass of focus detection areas that have been determined as “insufficient” is not detected even if the zone has been reached, an object may not exist in a zone ahead of the zone.

In step S808, the system control unit 107 examines whether there is a mass of a predetermined number or more of focus detection areas that have been determined as “insufficient” or focus detection areas that have been determined as “no good” out of N by M focus detection areas at the center. If the mass exists (YES in step S808), the processing proceeds to step S811. Otherwise (NO in step S811), the processing proceeds to step S809. In the present exemplary embodiment, the predetermined number is 20.

In step S809, the system control unit 107 examines whether there is a mass of a predetermined number or more of focus detection areas determined as “GOOD” out of M1 by M2 focus detection areas at the center. If the mass exists (YES in step S809), the processing proceeds to step S811. Otherwise (NO in step S809), the processing proceeds to step S810. In the present exemplary embodiment, the predetermined number is 10 as an example.

In step S810, the system control unit 807 determines that the zone updating is not performed and ends the determination processing. In step S811, the system control unit 107 determines that the zone updating is performed and ends the determination processing.

Although the predetermined numbers in steps S805, S806, S808, and S809 have been uniformly determined as described above, the predetermined number may be changed depending on a zone range or a focus lens position. For example, it is possible that the closer an object distance, the larger the predetermined number. The object distance can be found based on a focus lens position where an AF evaluation value becomes a peak.

### <Peak Position Selection Processing>

The peak position selection processing in step S414 illustrated in FIG. 4 will be described below with reference to FIG. 9.

The peak position selection in the present exemplary embodiment is, for example, processing for selecting a focus lens position at which an object in the focus detection area is in sharp focus (an AF evaluation value becomes a peak) from AF evaluation values α and β, in each of the focus detection areas in a matrix of nine rows and seven columns as illustrated in FIG. 5.

In step S901, the system control unit 107 determines whether the focus detection area serving as a peak position selection target uses both the AF evaluation values α and β.

If it has not been determined that in the focus detection area, both the AF evaluation values α and β (NO in step S901) are used, then in step S903, the system control unit 107 determines whether for the focus detection area serving as the peak position selection target the AF evaluation value α is used. If it has been determined that in the focus detection area the AF evaluation value α (YES in step S903) is used, then in step S904, the system control unit 107 uses a peak position determined by the AF evaluation value α as a peak position in the focus detection area. In step S908, the system control unit 107 then determines whether the determination have been made about all the focus detection areas. If the determination have been made about all the focus detection areas (NO in step S908), the processing returns to step S901.

If the determination have been made about all the focus detection areas (YES in step S908), the processing ends.

If it has not been determined that in the focus detection area the AF evaluation value α (NO in step S903) is used, then in step S905, the system control unit 107 uses a peak position determined by the AF evaluation value β as a peak position in the focus detection area. In step S908, the system control unit 107 then determines whether all the focus detection areas have been determined.

If the determination has not been made about all the focus detection areas (NO in step S908), the processing returns to step S901. If the determination has been made about all the focus detection areas (YES in step S908), the processing ends.

If it has been determined that in the focus detection area, both the AF evaluation values α and β (YES in step S901) are used, then in step S902, the system control unit 107 determines whether the peak position determined by the AF evaluation value α and the peak position determined by the AF evaluation value β are separated by a predetermined amount or more. The predetermined amount is a depth 1 as a range where the focus lens is in-focused at both the peak positions in the present exemplary embodiment. If it has been determined that the peak positions are separated by the predetermined amount or more (YES in step S902), the processing proceeds to step S909. Otherwise (NO in step S902), the processing proceeds to step S907. In step S909, the system control unit 107 determines whether a gain amount of either the High image or the Low image is a predetermined amount or more. If the gain amount is the predetermined amount or more (YES in step S909), the processing proceeds to step S907. Otherwise (NO in step S909), the processing proceeds to step S906.

In step S906, the system control unit 107 preferentially selects the peak position, where the focus lens can focus closer to the imaging apparatus, according to a closer distance priority idea. On the other hand, in step S907, the system control unit 107 selects the peak position with respect to the higher one between the AF evaluation values α and β. That is because if the AF evaluation value is larger, a more reliable peak position is obtained. If the processing in step S906 or S907 ends, then in step S908, the system control unit 107 determines whether all the focus detection areas have been determined. If all the focus detection areas have not been determined (No in step S908), the processing returns to step S901. If all the focus detection areas have been determined (YES in step S908), the processing ends.

There can be a case where objects are mixed in a focus detection area, e.g., the focus direction area (605) illustrated in FIG. 6 and the focus detection area (705) illustrated in FIG. 7 (a house in a foreground and a tree in a background exist in each of the focus detection areas illustrated in FIGS. 6 and 7), for example. In this case, a peak position is calculated from both an AF evaluation value in the foreground and an AF evaluation value in the background so that a correct peak position cannot be obtained depending on an exposure condition. However, a difference between the AF evaluation values in the foreground and the background increases if the exposure condition is changed. Thus, a peak position where the foreground is correctly focused on can be selected. Therefore, when a closer distance is preferentially selected, the correct peak position is obtained. In the examples illustrated in FIGS. 6 and 7, in the Low image, a peak position is calculated from both the AF evaluation value in the foreground and the AF evaluation value in the background. On the other hand, in the High image, the background is overexposed so that the AF evaluation value in the background decreases and the AF evaluation value in the foreground increases, and a peak position where the foreground is correctly focused on can be selected. When the closer distance is preferentially selected, the correct peak position is obtained.

While a case where the closer distance is preferentially selected has been described above, a peak position may be selected by referring to a histogram of a luminance value of pixels in a focus detection area. If two peak positions, which differ by a predetermined amount or more, exist in a histogram in a High image and Max_hs exists in one of the peak positions, for example, the closer peak position is selected. If both the peak positions of the histogram exist near the center, AF evaluation values differ by a predetermined amount or more, and the AF evaluation value at the farther peak position is larger, the farther peak position may be selected.

It can be seen whether an area serving as a foreground or a background is overexposed in the area where the objects are mixed, by observing a region around an area where objects are mixed. Accordingly, in an area where there is a difference between peak positions, if an area having a farther peak is found to be overexposed in a High image by viewing a histogram of a luminance value around the area, it is determined that a background is overexposed so that an AF evaluation value may decrease.

As described above, according to the present exemplary embodiment, the peak position in the division area can correctly be acquired by using the High image and the Low image. Such information can be used for focus bracket shooting and scene determination.

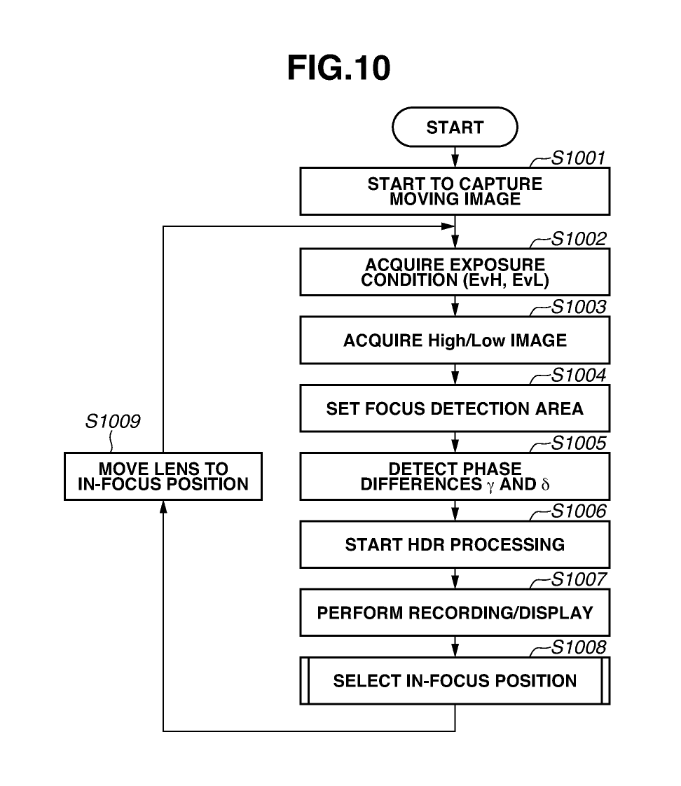

An operation of an imaging apparatus according to a second exemplary embodiment will be described with reference to FIG. 10.

Description of components common to those in the first exemplary embodiment is not repeated in the present exemplary embodiment. In the present exemplary embodiment, the contrast AF system described in the first exemplary embodiment is replaced with a phase difference AF system.

In the present exemplary embodiment, an image sensor 102 includes a plurality of focus detection pixels for dividing a pupil area of an imaging optical system and photoelectrically converting an object image from the divided pupil area. Output signal from the focus detection pixels is read out when a High image and a Low image are read out of the image sensor 102. A phase difference between image signals is detected as a focus signal using the output signals from the plurality of focus detection pixels that has performed the photoelectric conversion to adjust focus.

In the following description, γ is a phase difference corresponding to the High image, and δ is a phase difference corresponding to the Low image. When a power supply is turned on by an operation of a power switch in an operation unit 109, power is supplied to each of the units in the imaging apparatus from a power supply unit 111. A system control unit 107 performs various types of initial settings, to enter a shooting standby state.

In step S1001, the system control unit 107 starts to capture a moving image for recording when a video recording button in the operation unit 109 is operated in this state The system control unit 107 starts to shoot a live view video to be displayed on a display unit 104 during a standby even if the video recording button is not operated. In either case, HDR moving image shooting is performed. Description is made below without distinguishing between the live view video and a video for recording.

In step S1002, the system control unit 107 calculates a proper exposure condition using any known method as a reference, and increases by plus step and decreases by minus step a target luminance level from the proper exposure condition, to respectively determine a High-image exposure (Ev (H)) and a Low-image exposure (Ev (L)). The system control unit 107 adjusts (increases and decreases) a shutter speed (in addition, sensitivity (a gain amount), as needed) by one step from the proper exposure condition, to respectively determine exposures Ev (H) and Ev (L). The system control unit 107 controls a charge accumulation time in the image sensor 102, to control the shutter speed.

In step S1003, the system control unit 107 performs control, to perform imaging under different exposure conditions, respectively, on Odd and Even lines in the image sensor 102 based on the exposure conditions Ev (H) and Ev (L), which have been determined in step S1002. Thus, the High image and the Low image and output signals of a plurality of focus detection pixels can be acquired in one frame period. The system control unit 107 stores the High image and the Low image and the output signals for the focus detection pixels, which have been acquired, in the frame memory 112.

In step S1004, the system control unit 107 performs face recognition processing on the High image and the Low image in a face detection unit (not illustrated), detects a face area of a character in an imaging screen, and transmits a detection result to the system control unit 107. The system control unit 107 transmits information to the focus detection unit 106 so that an area used for focus detection (a focus detection area) is set at a position including the face area in the imaging screen based on the detection result. The face recognition processing includes a method for extracting a skin color area from a gradation color of each of pixels represented by image data and detecting the face, depending on how much degree the image data matches with a contour plate of a face previously prepared. Further, a method for detecting a face by extracting feature points of the face such as eyes, a nose, and a mouth using a well-known pattern recognition technique is disclosed. A method for the face recognition processing is not limited to the above-mentioned method. Any method is available.

In step S1004, the system control unit 107 sets the focus detection area based on the position and the size of the face if the face has successfully been recognized, and sets the focus detection area at the center of the imaging screen if the face has unsuccessfully been recognized.

In step S1005, the system control unit 107 detects a pair of image signals and a phase difference therebetween using a plurality of image output signals, from focus detection pixels in the image sensor 102 in the focus detection area, which has been set in step S1004. The plurality of image output signals is obtained by photoelectrically converting light beams that have passed through different exit pupils. A phase difference γ corresponding to the High image and a phase difference δ corresponding to the Low image are detected so that defocus amounts of object images respectively corresponding to the High image and the Low image can be detected. In-focus positions of a focus lens are respectively found from the defocus amounts.

In step S1006, the system control unit 107 causes a video signal processing unit 103 to start combining processing for generating an HDR image (a composite image) from the High image and the Low image stored in the frame memory 112.

In step S1007, the system control unit 107 causes the video signal processing unit 103 to perform development processing for developing the HDR image that has been generated in step S1006. The system control unit 107 records the HDR image as a moving image in a storage unit 110 or displays the HDR image as a live view on a display unit 104 after the development processing. The HDR image, which is recorded and displayed in step S1007, is a composite image of a High image and a Low image that have been captured in the preceding frame period.

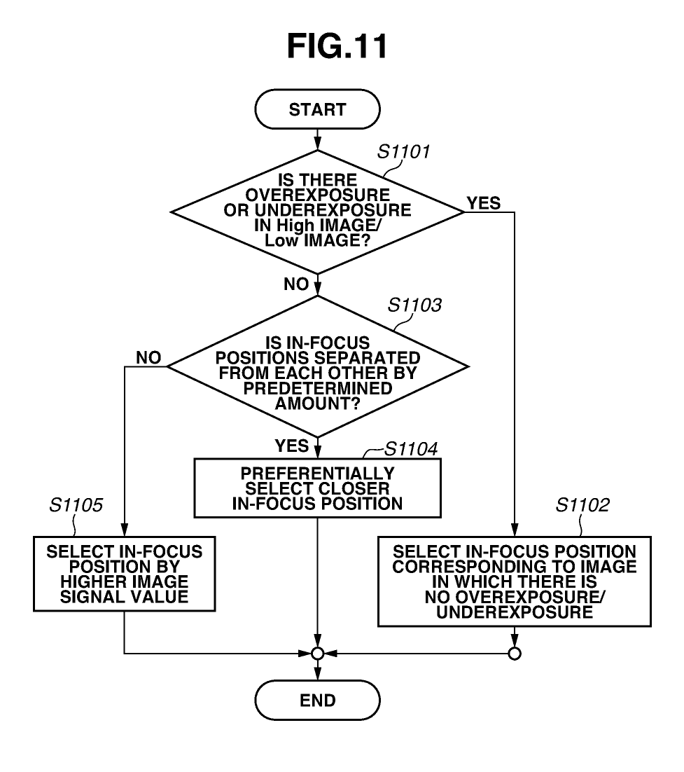

In step S1008, the system control unit 107 selects one of the in-focus position of the focus lens corresponding to the High image and the in-focus position of the focus lens corresponding to the Low image that have been detected in step S1005. A method for selecting the in-focus position will be described below with reference to FIG. 11.

In step S1009, the system control unit 107 moves the focus lens to the in-focus position, which has been selected in step S1008, and performs focus adjustment. The processing in step S1002 and the subsequent steps is repeated.

The in-focus position selection processing in step S1008 illustrated in FIG. 10 will be described below with reference to FIG. 11.

In step S1101, the system control unit 107 acquires signal levels (luminance values) of respective pixels in the High image and the Low image. The system control unit 107 determines whether either one of the High image and the Low image is overexposed or underexposed by using the histogram of the luminance value, described with reference to FIGS. 6 and 7 in the first exemplary embodiment. If either one of the High image and the Low image is overexposed or underexposed (YES in step S1101), then in step S1102, the system control unit 107 selects an in-focus position corresponding to the image that is not overexposed or underexposed. If overexposure or underexposure occurs as data representing the luminance value of the image, the possibility that the reliability of a focus signal based on an output signal of the image from the image sensor, deteriorates, resulting in erroneous detection of the in-focus position, is previously excluded by the selection of an in-focus position.

On the other hand, if neither the High image nor the Low image is overexposed or underexposed (NO in step S1101), the processing proceeds to step S1103. In step S1103, the system control unit 107 determines whether the in-focus position by the phase difference γ and the in-focus position by the phase difference 5 separate from each other by a predetermined amount or more. In the present exemplary embodiment, the predetermined amount is defined a depth 1 as a range where the focus lens can focus at both of the in-focus positions. If it has been determined that the in-focus positions separate from each other by a predetermined amount or more (YES in step 1103), the processing proceeds to step S1104. Otherwise (NO in step S1103), the processing proceeds to step S1105.

In step S1104, the system control unit 107 preferentially selects the in-focus position, where the focus lens can focus being closer to the imaging apparatus, according to a closer distance priority idea. On the other hand, in step S1105, the system control unit 107 uses the in-focus position obtained by the higher one between the image signals used in obtaining the phase differences γ and δ. If the image signal is larger, a more reliable in-focus position is obtained.

As described above, according to the present exemplary embodiment, the in-focus position can be correctly acquired by using the High image and the Low image.

While an example in which the focus detection method using the contrast AF system and the focus detection method using the phase difference AF system have respectively be described in the first exemplary embodiment and the second exemplary embodiment, the present invention is not limited to these methods.

With such a configuration, there can be provided an imaging apparatus capable of improving the detection accuracy of an in-focus position of an imaging optical system when a composite image is acquired, and a method for controlling the imaging apparatus.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)·), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-139006 filed Jul. 2, 2013, which is hereby incorporated by reference herein in its entirety.

What is claimed is:

1. A focus detection apparatus comprising:
a focus detection unit configured to detect a focus signal from each of a plurality of image signals obtained on different exposure conditions to be output from an imaging unit to combine images to generate a composite image in one frame; and
a selection unit configured to find a plurality of in-focus positions respectively corresponding to the exposure conditions based on the focus signals detected by the focus detection unit and select the in-focus position where focusing is to be performed out of the plurality of in-focus positions.

2. The focus detection apparatus according to claim 1, further comprising an image combining unit configured to combine the plurality of image signals obtained on different exposure conditions to be output from the imaging unit, to generate the composite image in one frame,
wherein the focus detection unit detects, when the image combining unit continuously outputs the composite images, the focus signal from each of the plurality of image signals obtained on different exposure conditions that are yet to be combined.

3. The focus detection apparatus according to claim 1, wherein the plurality of image signals has different exposure times.

4. The focus detection apparatus according to claim 1, wherein the imaging unit outputs the plurality of image signals with different exposures in one frame period of a predetermined moving image.

5. The focus detection apparatus according to claim 1, wherein the plurality of image signals is output from the imaging unit at different target luminance levels.

6. The focus detection apparatus according to claim 1, further comprising:
a first determination unit configured to determine whether the image signals output from the imaging unit are overexposed or underexposed,
wherein the selection unit selects the in-focus position corresponding to the image signal that is less overexposed or underexposed in preference to the in-focus position corresponding to the image signal that is more overexposed or underexposed.

7. The focus detection apparatus according to claim 6, wherein the first determination unit determines whether the image signals are overexposed or underexposed based on a histogram of a luminance value of the image signals.

8. The focus detection apparatus according to claim 1, further comprising a second determination unit configured to determine whether the plurality of in-focus positions respectively corresponding to the exposure conditions separates from each other by a predetermined amount or more,
wherein the selection unit selects the closer in-focus position in a case where the second determination unit determines that the in-focus positions separate from each other by the predetermined amount or more.

9. The focus detection apparatus according to claim 8, wherein the selection unit selects the in-focus position detected based on the higher focus signal in a case where the second determination unit determines that the in-focus positions do not separate from each other by the predetermined amount or more.

10. The focus detection apparatus according to claim 1, wherein
the focus signal is an AF evaluation value representing a contrast obtained based on the image signals,
the focus detection unit performs a scanning operation for sequentially acquiring a plurality of AF evaluation values with different exposure conditions from the plurality of image signals with different exposure conditions by moving a focus lens, and
the selection unit acquire the plurality of in-focus positions of the focus lens respectively corresponding to the exposure conditions based on the AF evaluation values, and selects the in-focus position where focusing is to be performed out of the plurality of in-focus positions.

11. The focus detection apparatus according to claim 1, wherein the focus signal is a phase difference between images formed by a pair of pupil-divided light fluxes.

12. The focus detection apparatus according to claim 1, wherein the selection unit outputs information about a distribution of the in-focus positions for each division area in one frame of the image signal, and selects a position of an imaging optical system for performing shooting a plurality of times by changing a position of the imaging optical system based on the distribution of the in-focus positions for the plurality of division areas.

13. The focus detection apparatus according to claim 12, wherein the plurality of areas is set based on a unit of repeating of a color filter in the imaging unit.

14. The focus detection apparatus according to claim 2, further comprises a storage control unit configured to perform control to store the composite image generated by the image combining unit in a memory for each frame.

15. A focus detection method comprising:
detecting a focus signal from each of a plurality of image signals obtained on different exposure conditions to be output from an imaging unit to combine images to generate a composite image in one frame; and
acquiring a plurality of in-focus positions respectively corresponding to the exposure conditions based on the detected focus signals and selecting the in-focus position where focusing is to be performed out of the plurality of in-focus positions.

16. A recording medium storing a program for causing a computer to function as each of the units in the focus detection apparatus according to claim 1.
